(19) United States
(12) Patent Application Publication
(10) Pub. No.: US 2010/0017834 A1
(43) Pub. Date: Jan. 21, 2010

(54) Apparatus and Method for Transmitting Multimedia Objects in Digital Multimedia Broadcasting

(76) Inventor: Hak Joo Lee, Seoul (KR)

Correspondence Address: MCKENNA LONG & ALDRIDGE LLP, 1900 K STREET, NW, WASHINGTON, DC, 20006, US

(21) Appl. No.: 12/084,058

(22) PCT Filed: Nov. 4, 2006
(86) PCT No.: PCT/KR2006/004582

§ 371 Date: Sep. 29, 2009

(30) Foreign Application Priority Data
Nov. 7, 2005 (KR) 10-2005-0106095

(51) Int. Cl. H04N 7/173

(52) U.S. Cl. 725/114

(57) ABSTRACT

An apparatus and method for transmitting multimedia objects in DMB is disclosed to reduce transfer delays and transfer errors during a multimedia object transfer by using a multimedia object transfer protocol in the digital multimedia broadcasting. The method for transmitting multimedia objects comprises; scheduling to-be-transmitted multimedia objects based on a pre-set number of iterative transfer times in such a manner that no identical multimedia objects are consecutively transmitted; inserting the scheduled multimedia objects into a transfer queues; and transmitting the transport queue-inserted multimedia objects to a Digital Multimedia Broadcasting receiving terminal via a multimedia object transfer protocol. As a result, transmission errors that occur during transmission of the multimedia objects to the digital multimedia broadcasting receiving terminal using the multimedia object transfer protocol can be prevented.

### BACKGROUND ART

This description relates to an apparatus and method for transmitting multimedia objects in Digital Multimedia Broadcasting (DMB), and more particularly to an apparatus and method for transmitting multimedia objects in DMB adapted to reduce transfer delays and transfer errors during a multimedia object transfer by using a multimedia object transfer protocol in the DMB.

The existing radio broadcasting currently in use has been developed for fixed reception in analog format, and has a considerable degradation in sound quality when a signal is received during walking or even in a vehicle driving especially at a high speed, thus requiring a high power output and a broad frequency band.

In order to address these and other drawbacks, standardization and commercialization of a digital audio broadcasting is being globally promoted.

Europe adopts Eureka-147 (European Research Coordination Agency Project-147) as a digital audio broadcast standard and uses a digital audio broadcasting (DAB) system, America uses a digital audio radio (DAR) system, Canada uses a digital radio broadcasting (DRB) system, the international telecommunication union-radio communication sector (ITU-R) uses a digital sound broadcasting (DSB) system and Korea adopts and uses a digital multimedia broadcasting (DMB) system.

The DMB system is a multimedia broadcasting concept capable of stably receiving moving pictures, CD-quality audio signals and various other types of multimedia data services using portable terminals such as, but not limited thereto, vehicle-mounted small-sized TVs, notebooks, PDAs (Personal Digital Assistants) without being affected by time and location. The DMB system has been locally standardized for the first time in the whole world and is ready for commercialized services.

The DMB adopted by Korea is based on Eureka-147 Digital Audio Broadcasting (DAB) adopted as European terrestrial radio standard. The DMB standardization has added a standard for providing moving pictures by adopting MPEG-4 (Moving Picture Experts Groups-4) techniques to the Eureka-147. Furthermore, the DMB standardization has already established or is establishing a standard for providing data services.

Most of the data services providable by the DMB system have a close relationship with broadcasting standardization process. The data service standards under consideration in DMB project group include a multimedia object transfer (MOT) protocol as data transfer protocol, an Internet Protocol (IP) tunneling and Transparent Data Channel (TDC). To be more specific, more detailed application services include MOT slide show, a BWS (Broadcast Web Site), XML-based EPG service and voice-based electronic program guide service.

The TDC is a standard capable of transmitting stream type data in order to support stream-based application, and is based on data transmission mechanism of DAB. The TDC, which is specified in the DAB, is used to transmit data in an intrinsic unlimited format defined by a broadcaster or a stream provider, and is used for transmitting TPEG (Transport Protocol Export Group) service requiring a real time information and securities information. The IP tunneling is a standard capable of transmitting Internet Protocol datagram using packet mode service components of DAB.

Meanwhile, the MOT in DAB is a transport protocol for the transmission of multimedia objects, such as text, still images, motion pictures, audio sequences, etc., in data channels of very high frequency (VHF) digital radio broadcasting, and includes rules related to the basic representation and operation of the objects. The MOT is also a protocol in a manner supportable for transmission of the multimedia objects in a file format using the transmission mechanism of the DAB. Program codes, image files, audio files and web pages may be transmitted using the MOT protocol.

The MOT protocol can be largely categorized into two types, that is, a Program Associated Data (PAD) accompanying data with reference to the respective programs and Non Program Associated Data (NPAD) that accompanies data without reference to the programs. The PAD is a transmitting manner multiplexed along with MUSICAM audio which is a basic audio service, while the NPAD is a method of independently and separately transmitted manner. The afore-mentioned MOT protocol, the TDC the IP tunneling, the MOT slide show, the broadcasting web site service standards basically belong to the NPAD which is independent data service.

Meanwhile, as the DMB service provides a single direction service like the conventional broadcasting service, it is impossible to check reception relative to multimedia objects. As a result, unlike the audio and video signals tolerating a predetermined amount of errors, problems resultant from errors of the received multimedia objects may significantly loom large.

Therefore, the MOT protocol of the DMB may prevent reception errors by repeatedly transmitting multimedia objects in file types. In the current MOT, transport objects are repeatedly transmitted, or the transport objects are divided into several segments, and the divided segments are repeatedly transmitted.

FIG. 1 is a schematic diagram illustrating a method for transmitting multimedia objects proposed in multimedia object transfer protocol of the current digital multimedia broadcasting, where repeated transmission of multimedia objects are explained.

Referring to FIG. 1, a case is illustrated where a multimedia object A divided into four segments of A1, A2, A3 and A4, and a multimedia object B divided into four segments of B1, B2, B3 and B4 are repeatedly transmitted three times each. First of all, four segments of A1, A2, A3 and A4 comprising the multimedia object A are sequentially and repeatedly transmitted three times. Once the transmission of the multimedia object A is completed, four segments of B1, B2, B3 and B4 comprising the multimedia object B are sequentially and repeatedly transmitted three times.

### DISCLOSURE OF INVENTION

### Technical Problem

However, if the multimedia objects are transmitted in the manner thus described, there may arise a problem of predetermined multimedia objects being all error-treated if there occur transmission errors. In other words, as illustrated in FIG. 2, if the multimedia objects A and B are to be repeatedly transmitted three times respectively, there may occur a problem of the multimedia object A being treated of having experienced a transmission error when errors occur in a section from which the multimedia object A is transmitted.

### Technical Solution

The following is disclosed to solve the afore-mentioned problems and an object is to provide an apparatus and method for transmitting multimedia objects in Digital Multimedia Broadcasting wherein to-be-transmitted multimedia objects are scheduled based on a pre-set number of iterative transfer times and transmitted to thereby enable to reduce transmission errors that occur during transmission of the multimedia objects using the multimedia object transfer protocol.

In one general aspect, an apparatus for transmitting multimedia objects in Digital Multimedia Broadcasting comprises: a multimedia object generator for generating multimedia objects to be transmitted to a digital multimedia broadcasting receiving terminal by using a Multimedia Object Transfer protocol; a controller for scheduling the multimedia objects generated by the multimedia object generator based on a pre-set number of iterative transfer times, where the scheduling is performed in such a manner that identical multimedia objects are not consecutively transmitted; a transfer queue for queuing the multimedia objects scheduled by the controller in the order of input; and a multimedia object transmitter for transmitting the multimedia objects queued by the transfer queue via a Digital Multimedia Broadcasting network.

Implementations of this aspect may include one or more of the following features.

The pre-set number of iterative transfer times can be established on a different basis relative to each multimedia object which is to be transmitted.

The controller schedules the multimedia objects in such a fashion that the multimedia objects inputted from the multimedia object generator are transmitted in proportion to the pre-set number of iterative transfer times, where the scheduling is performed on an alternative transmission basis.

In another general aspect, a method for transmitting multimedia objects in Digital Multimedia Broadcasting comprises: scheduling to-be-transmitted multimedia objects based on a pre-set number of iterative transfer times in such a manner that no identical multimedia objects are consecutively transmitted; inserting the scheduled multimedia objects into a transfer queue; and transmitting the transport queue-inserted multimedia objects to a Digital Multimedia Broadcasting receiving terminal via a Multimedia Object Transfer protocol.

Implementations of this aspect may include one or more of the following features.

The pre-set number of iterative transfer times can be established on a different basis relative to each multimedia object which is to be transmitted.

The scheduling step is performed in such a manner that the multimedia objects are so scheduled as to be transmitted in proportion to the pre-set number of iterative transfer times, where the scheduling is performed on an alternative transmission basis.

### ADVANTAGEOUS EFFECTS

There is an advantage in the apparatus and method for transmitting multimedia objects in Digital Multimedia Broadcasting (DMB) thus described according to the present invention in that to-be-transmitted multimedia objects are scheduled based on a pre-set number of iterative transfer times in such a manner that no identical multimedia objects are consecutively transmitted, thereby preventing reception error caused by transmission error and predetermined multimedia objects from being deleted altogether at the same time even if transmission error occurs during transmission of the multimedia objects.

In other words, there is a problem in a method for transmitting multimedia objects proposed by the current MOT protocol of the DMB in that certain multimedia objects are all lost when a transmission error occurs. However, there is an advantage in the method for transmitting the multimedia objects according to the present invention in that the multimedia objects can be dispersedly transmitted to thereby enable to reduce the loss of the multimedia objects caused by the transmission error. Furthermore, there is another advantage in that delay of transmission time relative to specific multimedia objects can be effectively obviated if re-transmission of the specific multimedia objects caused by the transmission error is taken into account.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating a method for transmitting multimedia objects proposed in multimedia object transfer protocol of the current digital multimedia broadcasting;

FIG. 2 is a schematic diagram illustrating problems that occur during multimedia object transmission using a method proposed in the multimedia object transfer protocol of the current digital multimedia broadcasting;

FIG. 3 is a schematic block diagram illustrating an apparatus for transmitting multimedia objects in a digital multimedia broadcasting of the present invention;

FIG. 4 is a schematic diagram illustrating a structure of multimedia object of the present invention;

FIG. 5 is a flowchart illustrating a method for transmitting multimedia objects according to one embodiment of the present invention; and

FIGS. 6 and 7 are schematic diagrams illustrating a method for transmitting multimedia objects according to one embodiment of the present invention.

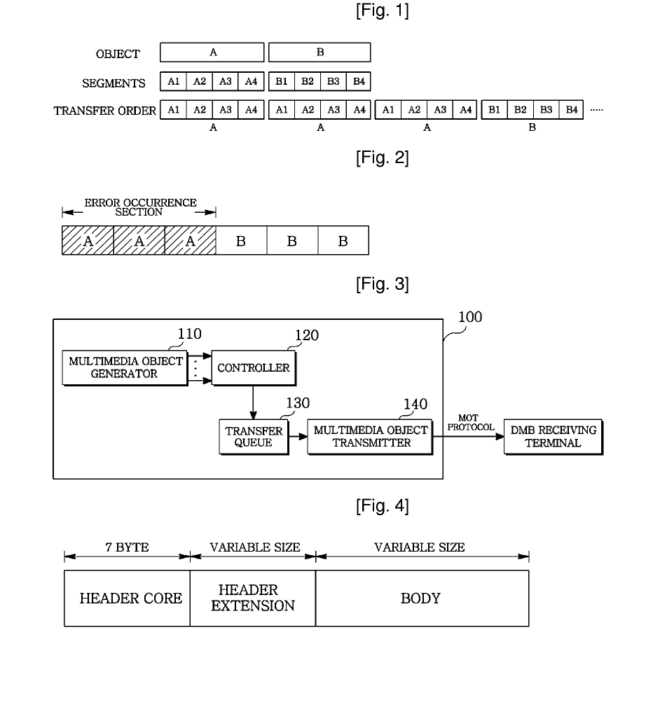

### MODE FOR THE INVENTION

Hereinafter, a preferred embodiment will be described herein below with reference to the accompanying drawings. In the following description, well-known functions or constructions are not described in detail for the sake of clarity.

FIG. 3 is a schematic block diagram illustrating an apparatus for transmitting multimedia objects in a digital multimedia broadcasting of the present invention.

Referring to FIG. 3, an apparatus (100) for transmitting multimedia objects may include a multimedia object generator (110), a controller (120), a transfer queue (130) and a multimedia object transmitter (140). The multimedia object generator (110) generates multimedia objects such as texts, still images, motion pictures, audio sequences in a file format and then outputs to the controller (120).

The controller (120) controls an overall operation of the apparatus for transmitting multimedia objects according to the present invention. The controller (120) stores information on the number of iterative transfer times relative to a plurality of multimedia objects transmitted from the multimedia object generator (110). The number of iterative transfer times may be differently established according to the multimedia objects to be transmitted.

The controller (120) receives the to-be-transmitted multimedia objects from the multimedia object generator (110) via a broadcasting network, and schedules the inputted multimedia objects based on the pre-set number of iterative transfer times and then outputs to the transfer queue (130).

The transfer queue (130) functions to queue the multimedia objects outputted from the controller (120) in the order of input and to output the multimedia objects. A queue defines a buffer structure in First-In and First-Out (FIFO) mode for outputting data stored in a limited memory region in the order of storage. The transfer queue (130) according to the present invention defines a queue in which multimedia objects to be transmitted to a digital multimedia broadcasting receiver via a broadcasting network are stored. Therefore, anything that can store multimedia objects may be defined as an object queue, and likewise, anything that can store segments in which the multimedia objects are divided may be called as a segment queue.

The multimedia object transmitter (140) acts to transmit to the digital multimedia broadcasting receiver the multimedia objects stored in the transfer queue (130) via a multimedia object transfer (MOT) protocol. The multimedia object transfer protocol is a protocol that enables to transmit multimedia objects such as texts, still images, motion pictures, audio sequences in a file format.

The multimedia object comprising the MOT protocol structurally includes a header core, a header extension and a body, as illustrated in FIG. 4.

The header core has information on the size and contents of the multimedia object. Specifically, the header core is composed of four sub-fields, i.e., a body size of 28 bits, a header size of 13 bits, a content type of 6 bits and a content subtype of 9 bits, so a header core field is 7 bytes (56 bits) long.

The header extension contains information required for processing the multimedia object as well as additional information to be used for specific applications. The body includes a substantial multimedia object. The header extension and the body are variable in length thereof. The multimedia objects according to the present invention are transmitted in the structures thus described.

The apparatus for transmitting multimedia objects thus described is operated in such a manner that the multimedia objects to be transmitted are scheduled based on the pre-set number of iterative transfer times, and the scheduled multimedia objects are inserted into the transfer queue (130). Furthermore, the multimedia objects inserted into the transfer queue (130) are sequentially read and then transmitted in a FIFO (First-in and First-Out) mode.

The controller (120) schedules the to-be-transmitted multimedia objects based on a pre-set number of iterative transfer times in such a manner that no identical multimedia objects (or segments belonging to the multimedia objects) are consecutively transmitted. In other words, the controller (120) schedules in such a fashion that the to-be-transmitted multimedia objects are alternatively transmitted.

For example, in a case where there are two to-be-transmitted multimedia objects, A and B, and the pre-set number of iterative transfer times are respectively three times, the multimedia objects scheduled by the controller (120) may be transmitted in the order of A→B→A→B→A→B→A→B, or in the order of B→A→B→A→B→A→B→A.

If the multimedia objects are dispersed and repeatedly transmitted as described above, that is, if the multimedia objects are alternatively transmitted, the multimedia objects A and B are prevented from being error-processed altogether at the same time even if transmission errors occur at a specific point.

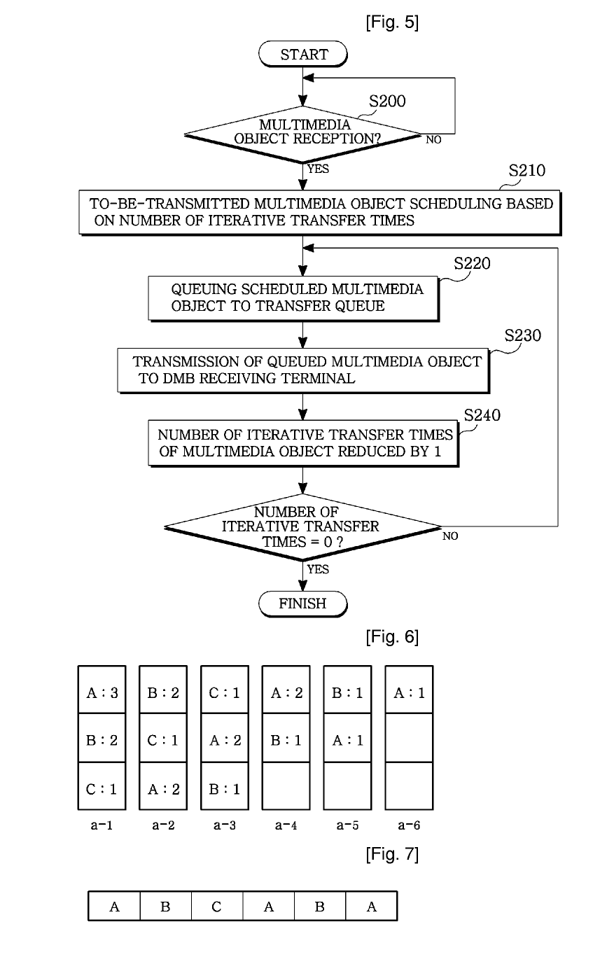

FIG. 5 is a flowchart illustrating a method for transmitting multimedia objects according to one embodiment of the present invention.

Referring to FIG. 5, the controller (120) schedules the multimedia objects according to the pre-set number of iterative transfer times when the multimedia objects to be transmitted from the multimedia object generator (110) via a DMB network are inputted, but in such a manner that no identical multimedia objects are consecutively transmitted (S200, S210). In other words, the controller (120) schedules in such a way that the to-be-transmitted multimedia objects are alternatively transmitted. The multimedia objects thus scheduled are inputted into the transfer queue (130).

The transfer queue (130) queues the multimedia objects scheduled by the controller (120) in the order of input (S220). The multimedia object transmitter (140) sequentially reads the multimedia objects queued by the multimedia object transmitter (140) and then transmits to the DMB receiver via the MOT protocol (S230).

The controller (120) reduces the number of iterative transfer times of relevant multimedia objects whenever the multimedia objects queued to the transfer queue (130) by the multimedia object transmitter (140) are transmitted (S240).

The controller (120) determines whether the number of iterative times of each multimedia object is zero (S250). Successively, the controller (120) inputs again to the transfer queue (130) the multimedia objects that are not zero in the number of iterative times, i.e., the multimedia objects that have not been transmitted as many as the number of iterative transfer times, and implements repeated performances from S220 to S250.

By this, the multimedia objects can be transmitted as many as the pre-set number of iterative times. Specifically, as the multimedia objects are alternatively transmitted, the problem of particular multimedia objects being lost at the same time during the occurrence of transmission error can be avoided.

Hereinafter, a method for transmitting multimedia objects according to another embodiment of the present invention will be described in detail with reference to FIG. 6.

FIG. 6 is a schematic diagram illustrating a process of multimedia objects being queued to the transfer queue (130), particularly to an object queue, and FIG. 7 is a schematic diagram illustrating an order of the multimedia objects being transmitted via the DMB network.

The method for transmitting multimedia objects in Digital Multimedia Broadcasting according to another embodiment of the present invention comprises: inserting into an object queue a plurality of multimedia objects, each having a predetermined number of iterative transfer times; transmitting a First-In object from objects inserted into the object queue on a First-Out queuing scheme; subtracting the number of iterative transfer times of the transmitted object and re-inserting the object having the subtracted predetermined number of iterative transfer times into the object queue; transmitting a First-In object of the object queue including the re-inserted object on a First-Out queuing scheme, wherein the subtracting and re-inserting steps, and the step of transmitting a First-In object of the object queue are repeatedly performed.

Referring to FIG. 6, an exemplary embodiment of an object queue will be described wherein the object queue is constructed in such a manner that there are three to-be-transmitted multimedia objects of A, B and C, each number of iterative transfer times is 3 times, 2 times and one times, and the transfer queue (130) can queue up to three multimedia objects.

Firstly, the controller (120) according to the present invention inserts into an object queue a plurality of to-be-transmitted multimedia objects each having a predetermined number of iterative transfer times. In other words, the to-be-transmitted multimedia objects of A, B and C are sequentially inserted into the object queue in the order of A, B and C, as shown in a-1 of FIG. 6.

As a result, the multimedia objects stored in the object queue are sequentially transmitted in the order of input. The multimedia object transmitter (140) transmits a First-In object among the objects inserted into the object queue on a First-Out queuing scheme. In other words, the first inputted A out of the multimedia objects stored in the object queue is read and transmitted. In that case, the transmitted multimedia object is removed from the object queue.

Furthermore, the controller (120) subtracts the number of iterative transfer times of the transmitted object transmitted by the multimedia object transmitter (140) and re-inserts the object into the object queue.

The subtraction of the number of iterative transfer times of the transmitted multimedia object is to subtract 1 from the pre-set number of iterative transfer times. In other words, as depicted in FIG. 6, the controller (120) reduces by 1 the number of iterative transfer times of the multimedia object A. Even if the number of iterative transfer times of the multimedia object A is reduced by 1, there still remains 2 times in the number of iterative transfer times.

The re-inserting into the object queue by subtracting the number of iterative transfer times is preferably a case where only objects whose subtracted number of iterative transfer times is of positive integer are re-inserted into the object queue, and as a result, the multimedia object A can be inserted into the object queue again. Therefore, the order of the multimedia objects stored in the object queue and the number of iterative transfer times of the objects can be illustrated as in a-2 of FIG. 6.

In still another embodiment of the present invention, the step of the controller (120) subtracting the number of iterative transfer times of the multimedia object and re-inserting the object into the object queue may include a step of determining whether the subtracted number of iterative transfer times is positive integer, zero or negative integer, and re-inserting the object into the object queue only if it is determined that the subtracted number of iterative transfer times is positive integer. In this case, it is preferred that the object be deleted from the object queue if the subtracted number of iterative transfer times is zero or negative integer.

Successively, the multimedia object transmitter (140) transmits a First-In object among the objects re-inserted into the object queue by the controller (120) on a First-Out queuing scheme. In other words, the First-In object B out of the object queues into which the multimedia object A is re-inserted (the object queue as shown in a-2 of FIG. 6) is transmitted.

When the multimedia object B stored in the object queue by the multimedia object transmitter (140) is read and transmitted, the controller (120) reduces again by 1 the number of iterative transfer times of the multimedia object B. It is preferred that the controller (120) control in such a fashion that the step of re-inserting into the object queue the multimedia object whose number of iterative transfer times has been subtracted, and the step of transmits the First-In object among the objects re-inserted into the object queue on the First-Out queuing scheme are repeatedly performed. Therefore, even if the number of iterative transfer times of the multimedia object B is reduced by 1, one time of the number of times to be iteratively transmitted still remains, such that the multimedia object B may be inserted into the object queue again. In this case, the order of the multimedia objects stored in the object queue is shown as in a-3 of FIG. 6.

Next in the transmitting order, a multimedia object C stored in the object queue is transmitted. Then, the controller (120) reduces by 1 the number of iterative transfer times of the multimedia object B. When the number of iterative transfer times of the multimedia object C is reduced by 1, the number of iterative transfer times becomes zero, and in this case, the multimedia object C is not inserted into the object queue. As a result, only the multimedia objects A and B are inserted into the object queue and stored as illustrated in a-4 of FIG. 6.

The above steps may be repeatedly performed by the controller (120) until the number of iterative transfer times of the multimedia objects A and B reaches zero. Then, a transmitting order of the multimedia objects may be determined as shown in FIG. 7. In other words, the to-be-transmitted multimedia objects may be repeatedly and alternatively transmitted three times, two times and one time, as many as the number proportional to the pre-set number of iterative transfer times, as depicted in FIG. 7.

Therefore, the plurality of to-be-transmitted multimedia objects according to the present invention may have the same number of iterative transfer times, and also has mutually different number of iterative transfer times. Particularly, it is preferred that an object having the largest number of iterative transfer times be first inserted into the object queue so that the multimedia objects can be evenly and alternatively repeated in the step of inserting the multimedia objects into the object queue. It is further preferred that insertions are sequentially performed in the order of from an object having a large number of iterative transfer times to an object having a small number of iterative transfer times.

According to the exemplary embodiment thus described, predetermined multimedia objects can be prevented from being lost altogether at the same time even if transmission errors occur during transmission of the multimedia objects.

Although the above-mentioned exemplary embodiment has described the multimedia objects to be transmitted, the multimedia objects may be divided into predetermined numbers of segments, and the divided segments may be inserted into the transfer queue (130. i.e., segment queue) per segment. A plurality of segments included in the to-be-transmitted multimedia objects may be also described in still another exemplary embodiment.

In other words, a method for transmitting multimedia objects in digital multimedia broadcasting according to still another embodiment of the present invention comprises: inserting into a segment queue a plurality of segments each having a predetermined number of iterative transfer times; transmitting a First-In segment among the segments inserted into the segment queue on the First-Out queuing scheme; subtracting the number of iterative transfer times of the transmitted segment and re-inserting the segment into the segment queue; and transmitting the First-In segment among the segments re-inserted into the segment queue on a First-Out queuing scheme, wherein the re-inserting step and the step of transmitting the First-In segment among the segments inserted into the segment queue on the First-Out queuing scheme are repeatedly performed.

Also, an apparatus for transmitting multimedia objects in digital multimedia broadcasting according to still another embodiment of the present invention comprise: a controller inserting into an segment queue a plurality of segments, each segment having a predetermined number of iterative transfer times, and belonging to the multimedia object; and a segment transmitter transmitting a First-In segment from segments inserted into the segment queue on a First-Out queuing scheme, wherein the controller subtracts the number of iterative transfer times of the transmitted segment and re-inserts the segment having the subtracted predetermined number of iterative transfer times into the segment queue, and the segment transmitter transmits a First-In segment on a First-Out queuing scheme from the segment queue including segment re-inserted by the controller, and wherein the controller controls in such a fashion that the steps of subtracting the number of iterative transfer times of the transmitted segment and re-inserting the segment the segment queue, and transmitting the First-In segment on the First-Out queuing scheme from the segment queue including segment re-inserted are repeatedly performed.

The above exemplary embodiment is the same as that of transmitting the to-be-transmitted multimedia objects, except that the afore-mentioned to-be-transmitted multimedia objects are performed by segments divided by the objects, such that a detailed description thereto will be replaced by the method and apparatus for transmitting the multimedia objects to be transmitted.

While the present invention has been described and illustrated herein with reference to the preferred embodiments thereof, it will be apparent to those skilled in the art that various modifications and variations can be made therein without departing from the spirit and scope of the invention. Therefore, the scope of the present invention includes the modifications and variations that shall be determined by the appended claims and their equivalents rather than by the embodiments described above.

### INDUSTRIAL APPLICABILITY

To-be-transmitted multimedia objects are scheduled based on a pre-set number of iterative transfer times in such a manner that no identical multimedia objects are consecutively transmitted, thereby preventing reception error caused by transmission error and predetermined multimedia objects from being deleted altogether at the same time even if transmission error occurs during transmission of the multimedia objects.

The multimedia objects can be dispersedly transmitted to thereby enable to reduce the loss of the multimedia objects caused by the transmission error. Delay of transmission time relative to specific multimedia objects can be effectively obviated if re-transmission of the specific multimedia objects caused by the transmission error is taken into account.

1. An apparatus for transmitting multimedia object in Digital Multimedia Broadcasting, the apparatus comprising: a multimedia object generator for generating multimedia objects to be transmitted to a digital multimedia broadcasting receiver by using a Multimedia Object Transfer protocol; a controller for scheduling the multimedia objects generated by the multimedia object generator based on a pre-set number of iterative transfer times, where the scheduling is performed in such a manner that no identical multimedia objects are consecutively transmitted; a transfer queue for queuing the multimedia objects scheduled by the controller in the order of input; and a multimedia object transmitter for transmitting the multimedia objects queued by the transfer queue via a Digital Multimedia Broadcasting network.

2. The apparatus as defined in claim 1, wherein the number of iterative transfer times can be established on a different basis relative to each multimedia object which is to be transmitted.

3. The apparatus as defined in claim 1, wherein the controller schedules the multimedia objects in such a manner that the multimedia objects inputted from the multimedia object generator are transmitted in proportion to the pre-set number of iterative transfer times, where the scheduling is performed on an alternative transmission basis.

4. A method for transmitting multimedia objects in Digital Multimedia Broadcasting, the method comprising: scheduling to-be-transmitted multimedia objects based on a pre-set number of iterative transfer times in such a manner that no identical multimedia objects are consecutively transmitted; inserting the scheduled multimedia objects into a transfer queue; and transmitting the transfer queue-inserted multimedia objects to a Digital Multimedia Broadcasting receiver via a Multimedia Object Transfer protocol.

5. The method as defined in claim 4, wherein the pre-set number of iterative transfer times can be established on a different basis for each multimedia object to be transmitted.

6. The method as defined in claim 4, wherein the scheduling step is performed in such a manner that the multimedia objects are so scheduled as to be transmitted in proportion to the pre-set number of iterative transfer times, where the scheduling is performed on an alternative transmission basis.

7. A method for transmitting multimedia objects, the method comprising: inserting into an object queue a plurality of multimedia objects, each having a predetermined number of iterative transfer times; transmitting a First-In object from objects inserted into the object queue on a First-Out queuing scheme; subtracting the number of iterative transfer times of the transmitted object and re-inserting the object having the subtracted predetermined number of iterative transfer times into the object queue; transmitting a First-In object of the object queue including the re-inserted object on a First-Out queuing scheme, wherein the subtracting and re-inserting steps, and the step of transmitting a First-In object of the object queue are repeatedly performed.

8. The method as defined in claim 7, wherein the re-inserting step comprises: subtracting the number of iterative transfer times of the transmitted object; and re-inserting into the object queue the object whose subtracted number of iterative transfer times is a positive integer.

9. The method as defined in claim 7, wherein the subtraction of the number of iterative transfer times of the transmitted object is to subtract 1 from the number of the iterative transfer times.

10. The method as defined in claim 7, wherein the re-inserting step comprises: determining whether the number of iterative transfer times is a positive integer, zero or a negative integer; and re-inserting the object into the object queue only if the subtracted number of iterative transfer times is a positive integer as a result of the determination.

11. The method as defined in claim 10, wherein the step of re-inserting the object into the object queue only if the subtracted number of iterative transfer times is a positive integer comprises deleting the object from the object queue if the subtracted number of iterative transfer times is zero or a negative integer as a result of the determination.

12. The method as defined in claim 7, wherein each of the plurality of multimedia objects has the number of iterative transfer times, each number of iterative transfer times being different from that of the other.

13. The method as defined in claim 12, wherein the step of inserting the multimedia objects into the object queue is to insert in the first place a multimedia object whose number of iterative transfer times is the largest.

14. The method as defined in claim 12, wherein the step of inserting the multimedia objects into the object queue is to insert in sequence of a multimedia object whose number of iterative transfer times is the largest to a multimedia object whose number of iterative transfer times is the smallest.

15. An apparatus for transmitting multimedia objects comprising: a controller inserting into an object queue a plurality of to-be-transmitted multimedia objects each having a predetermined number of iterative transfer times; and a multimedia object transmitter transmitting a First-In object from objects inserted into the object queue on a First-Out queuing scheme, wherein the controller subtracts the number of iterative transfer times of the transmitted object and re-inserts the object having the subtracted predetermined number of iterative transfer times into the object queue, and the multimedia object transmitter transmits a First-In object on a First-Out queuing scheme from the object queue including object re-inserted by the controller, and wherein the controller controls in such a fashion that the steps of subtracting the number of iterative transfer times of the transmitted object and re-inserting the object the object queue, and transmitting the First-In object on the First-Out queuing scheme from the object queue including object re-inserted are repeatedly performed.

16. The apparatus as defined in claim 15, wherein the controller re-inserts into the object queue the object whose subtracted number of iterative transfer times is a positive integer.

17. The apparatus as defined in claim 15, wherein the plurality of the to-be-transmitted multimedia objects have respectively mutually different number of iterative transfer times.

18. The apparatus as defined in claim 15, wherein the object queue into which the plurality of multimedia objects, each having a predetermined number of iterative transfer times, are inserted in sequence of a multimedia object whose number of iterative transfer times is the largest to a multimedia object whose number of iterative transfer times is the smallest.

19. A method for transmitting multimedia object, the method comprising: inserting into a segment queue a plurality of segments, each segment having a predetermined number of iterative transfer times, and belonging to the multimedia object; transmitting a First-In segment from segments inserted into the segment queue on a First-Out queuing scheme; subtracting the number of iterative transfer times of the transmitted segment and re-inserting the object having the subtracted number of iterative transfer times into the segment queue; and transmitting a First-In segment of the segment queue including the re-inserted segment on an First-Out queuing scheme, wherein the subtracting and re-inserting step, and the step of transmitting a First-In segment in the segment queue are repetitively performed.

20. An apparatus for transmitting multimedia objects comprising: a controller inserting into an segment queue a plurality of segments, each segment having a predetermined number of iterative transfer times, and belonging to the multimedia object; and a segment transmitter transmitting a First-In segment from segments inserted into the segment queue on a First-Out queuing scheme, wherein the controller subtracts the number of iterative transfer times of the transmitted segment and re-inserts the segment having the subtracted predetermined number of iterative transfer times into the segment queue, and the segment transmitter transmits a First-In segment on a First-Out queuing scheme from the segment queue including segment re-inserted by the controller, and wherein the controller controls in such a fashion that the steps of subtracting the number of iterative transfer times of the transmitted segment and re-inserting the segment the segment queue, and transmitting the First-In segment on the First-Out queuing scheme from the segment queue including segment re-inserted are repeatedly performed.
